(19) United States
(12) Patent Application Publication
(10) Pub. No.: US 2021/0096598 A1
(43) Pub. Date: Apr. 1, 2021

(54) FOLDABLE IMAGE DISPLAY DEVICE

(71) Applicant: GANANHANDONGJIDUL INC., Seoul (KR)

(72) Inventor: You Seob LIM, Goyang (KR)

(73) Assignee: GANANHANDONGJIDUL INC., Seoul (KR)

(21) Appl. No.: 17/117,118

(22) Filed: Dec. 10, 2020

Related U.S. Application Data
(63) Continuation-in-part of application No. PCT/KR2019/015414, filed on Nov. 13, 2019.

(30) Foreign Application Priority Data
Nov. 14, 2018 (KR) 10-2018-0139604

(51) Int. Cl. G06F 1/16

(52) U.S. Cl. CPC G06F 1/1641; G06F 1/1616

(57) ABSTRACT

A folding space member of a foldable image display device is disclosed. The member prevents hinge damage due to an external force action beyond an allowable range when the foldable image display device is in a folded state, and prevents scratches, nicks, damage to a plastic cover, etc., of a screen display surface caused by foreign matter flowing into folding space formed on a side of an inner folding surface. The member is realized in the form of an accessory detachable from the foldable image display device or may be integrally formed as a part of the foldable image display device, and even when the display device is in a folded state and the external force is applied to a hinge portion, a folding space insert and a folding space support serve to support and disperse the external force and close the folding space.

### CROSS-REFERENCE TO PRIOR APPLICATIONS

This application is a continuation-in-part application of PCT International Patent Application No. PCT/KR2019/015414, filed on Nov. 13, 2019, which claims priority of Korean Patent Application No. 10-2018-0139604, filed on Nov. 14, 2018, which are all hereby incorporated by reference in their entirety.

### TECHNICAL FIELD

The present invention relates to a member applied to folding space in a foldable image display device to prevent the foldable image display device having a flexible display from being suffered from hinge damages caused by an external force, scratches and nicks on a screen display surface, and damage to an encapsulated film, and more particularly, to a member that is applied to folding space formed on inner folding surfaces of a foldable image display device.

### BACKGROUND ART

A foldable image display device with a flexible display capable of being folded or unfolded has been distributed.

As the foldable image display device is folded or unfolded, it can have various shapes, and in this case, it has two or more hinges or other designs, so that when it is folded, folding space as empty space is formed on inner folding surfaces thereof.

Under such a configuration of the foldable image display device, however, foreign matters may enter the folding space, and further, an external force is applied to the folding space to cause the hinges to be easily damaged or broken.

Accordingly, there is a definite need to develop a new member for solving such a structural problem of the foldable image display device with the folding space when folded.

### DISCLOSURE

### Technical Problem

Accordingly, the present invention has been made to solve the above-mentioned problems, and it is an object of the present invention to provide a member applied to folding space of a foldable image display device that is capable of preventing hinges from being damaged when an external force is applied to the hinges in a state where the foldable image display device with the folding space as empty space formed on inner folding surfaces thereof is in a folded state.

It is another object of the present invention to provide a member applied to folding space of a foldable image display device that is capable of preventing foreign matters from entering the folding space when the foldable image display device is in a folded state.

It is still another object of the present invention to provide a member applied to folding space of a foldable image display device that is capable of allowing a credit card to be accommodated into the foldable image display device with the folding space as empty space formed on inner folding surfaces thereof when it is in a folded state, while having no change in a thickness of the foldable image display device when folded.

### Technical Solution

To accomplish the above-mentioned objects, according to one aspect of the present invention, there is provided a member for a foldable image display device, which is applied to a given internal area on folding space as empty space formed by inner folding surfaces and an inner circumferential surface of a fold axis when the foldable image display device is in a folded state, the member including one or more folding space supports each having a first folding space support whose one side surface is fixedly bonded to a given area of the inner folding surfaces forming the folding space and a second folding space support whose one side surface is fixedly bonded to the inner folding surface located on the opposite side to the side at which the first folding space support is located around the fold axis in such a manner as to supportingly come into contact with a protruding portion of the first folding space support when the foldable image display device is in the folded state and to be separated from the first folding space support when the foldable image display device is in an unfolded state.

To accomplish the above-mentioned objects, according to another aspect of the present invention, there is provided a member for a foldable image display device, which is applied to a given internal area on folding space as empty space formed by inner folding surfaces and an inner circumferential surface of a fold axis when the foldable image display device is in a folded state, the member including one or more single-shaped folding space supports whose one side surface is fixedly bonded to a given area of any one side surface of the inner folding surfaces forming the folding space.

According to the present invention, in this case, the member further includes: support fixing surfaces bonded or fixed to the inner folding surfaces; support contact surfaces formed by allowing the protruding surfaces of the first folding space supports and the second folding space supports on the opposite side to the support fixing surfaces to come into contact with each other when the foldable image display device is in the folded state or formed by allowing the single-shaped folding space supports to come into contact with the other side inner folding surface; and support slant surfaces formed slantly along the edges of the support fixing surfaces and the support contact surfaces of the first folding space supports, the second folding space supports, and the single-shaped folding space supports.

To accomplish the above-mentioned objects, according to yet another aspect of the present invention, there is provided a member applied to a given area of folding space as empty space formed by inner folding surfaces and an inner circumferential surface of a fold axis when a foldable image display device is in a folded state, the member including a folding space insert applied to a given internal area of the folding space in such a manner as to allow one side to come into contact with any one side inner folding surface forming the folding space to support an external force applied thereagainst and to allow the other side to come into contact with the other side inner folding surface to transfer the external force, so that the folding space insert supports and distributes the external force applied from outer folding surfaces and moves to the outer edges of the inner folding surfaces when the foldable image display device is in an unfolded state.

According to the present invention, in this case, the folding space insert has insert contact surfaces whose one side is flat to come into contact with the inner folding surfaces forming the folding space or is changed to a flat surface when contacted with the inner folding surfaces.

According to the present invention, in this case, the insert contact surfaces as the flat surfaces of the folding space insert have inclinations corresponding to the folding space.

### Advantageous Effects

According to the present invention, the following advantages can be obtained.

Firstly, the folding space insert as the member according to the present invention is applied to the folding space of the foldable image display device and the folding space supports are facingly applied separatedly to the outer edges from the folding space located on both side ends of the fold axis, so that when an external force is applied to hinges in a state where the foldable image display device is in a folded state, the folding space insert and the folding space supports serve to support and distribute the external force, thereby lowering the possibility that the hinges may be damaged.

Secondly, the folding space supports, which are facingly applied separatedly to the outer edges of the folding space located on both side ends of the fold axis, serve to close the outer edges of the folding space when the foldable image display device is in a folded state, thereby preventing foreign matters causing the inner folding surfaces to be scratched or nicked from entering the folding space.

Thirdly, the folding space insert applied to the folding space of the foldable image display device has credit card accommodation space so that the credit card can be accommodated into the foldable image display device, while having no change in a thickness of the foldable image display device.

### DESCRIPTION OF DRAWINGS

FIGS. 1A and 1B are concept views showing folded states of an in-folding type image display device and an out-folding type image display device.

FIGS. 2A and 2B are concept views showing unfolded states of the in-folding type image display device and the out-folding type image display device.

FIGS. 3A and 3B are front and plan views showing a folding space insert according to the present invention which is applied to an in-folding type image display device being in a folded state.

FIGS. 4A and 4B are sectional views taken along the lines A-A and B-B of FIG. 3A.

FIGS. 5A and 5B are plan and sectional views showing the folding space insert applied to an in-folding type image display device being in an unfolded state and taken along the line C-C.

FIGS. 6A and 6B are plan and sectional views showing a state where the folding space insert of FIGS. 5A and 5B moves and taken along the line C-C.

FIGS. 7A and 7B are concept views showing a state where a credit card is accommodated into the folding space insert.

FIGS. 8A and 8B are concept views showing a folding space insert according to the present invention which is applied to an out-folding type image display device being in a folded state.

FIGS. 9A and 9B are front and plan views showing folding space supports according to the present invention which is applied to an in-folding type image display device being in a folded state.

FIGS. 10A to 10C are sectional views taken along the lines D-D, E-E, and F-F of FIG. 9A.

FIGS. 11A and 11B are front and plan views showing the folding space supports applied to the in-folding type image display device being in an unfolded state.

FIGS. 12A to 12C are front, plan, and sectional views showing an edge cover additionally provided to the folding space insert of FIGS. 8A and 8B.

### EXPLANATIONS ON REFERENCE NUMERALS

10: foldable image display device
11: fold axis
12: outer folding surface
13: inner folding surface
14: folding space
15: folding space support left surface
16: folding space fixing support
17: fixing support contact surface
18: fixing support slant surface
19: flexible display
20: credit card
100: folding space insert
110: insert contact surface
120: credit card accommodation space
121: credit card entrance
130: insert connection string or connection plate
200: folding space support
210: first folding space support
220: second folding space support
230: support fixing surface
240: support contact surface
250: support slant surface
300: edge cover
310: edge cover connection string

### BEST MODE FOR INVENTION

Hereinafter, the present invention will now be described in detail with reference to the attached drawings.

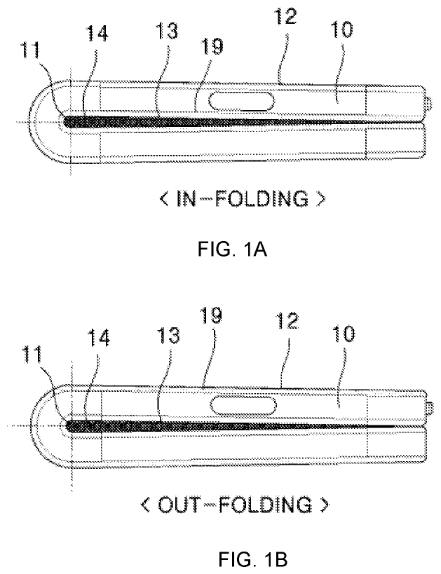

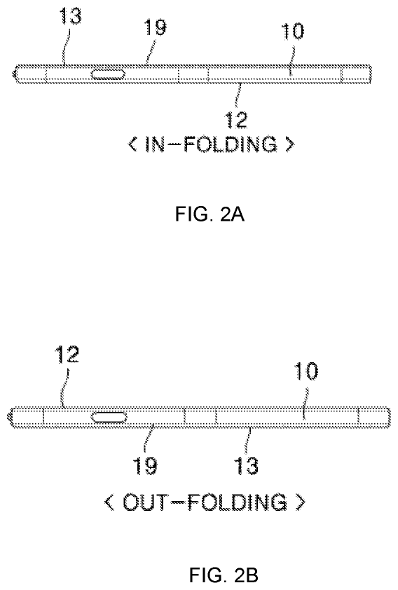

FIGS. 1A and 1B are concept views showing folded states of an in-folding type image display device and an out-folding type image display device, and FIGS. 2A and 2B are concept views showing unfolded states of the in-folding type image display device and the out-folding type image display device.

When the foldable image display device 10 is in a folded state, as shown in FIGS. 1A and 1B, if inner folding surfaces 13 located on inner sides of folding surfaces of the foldable image display device 10 have folding space 14 narrow gradually from a fold axis 11, without coming into close contact with each other, the folding space 14 as empty space formed by the inner circumferential surface of the fold axis 11 and the inner folding surfaces 13 slantly facing each other is formed penetratedly from one side of the fold axis 11 to the opposite end to one side.

If the foldable image display device 10 is unfolded to open a closed space, as shown in FIGS. 2A and 2B, the folding space 14 as shown in FIGS. 1A and 1B disappears.

If an external force is applied to outer folding surfaces 12 of the foldable image display device 10 with the folding space 14 as shown in FIGS. 1A and 1B, the external force is collected to the circumferential surface of the fold axis 11 according to the principle of the lever, so that hinge components only with the circumferential surface thereof, without having any internal support structures, may be deformed or destroyed by means of the external force.

Such problems occur in both of the in-folding type image display device and the out-folding type image display device.

As the folding space 14 is penetratedly formed along the fold axis 11, as shown in FIGS. 1A and 1B, foreign matters with hard and sharp portions may be freely introduced and remain therein.

In the state where the foreign matters with hard and sharp portions may be freely introduced into the folding space 14 and thus remain therein, if the folded state is changed to the unfolded state, the foreign matters caught between the inner folding surfaces 13 may insertedly enter the inner folding surfaces 13, thereby undesirably causing nicks of the inner folding surfaces 13 or penetration into the inner folding surfaces 13.

So as to solve the hinge damage problem and the foreign matter introduction problem caused by the folding space 14, accordingly, embodiments of the present invention will be explained below.

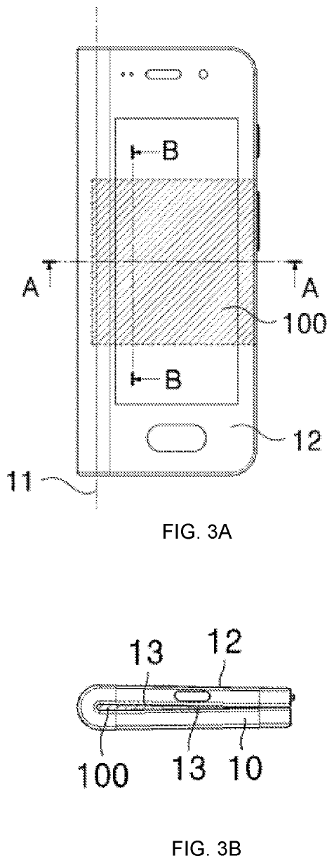

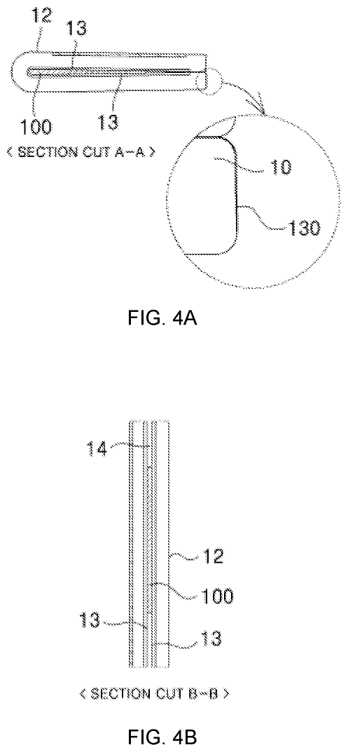

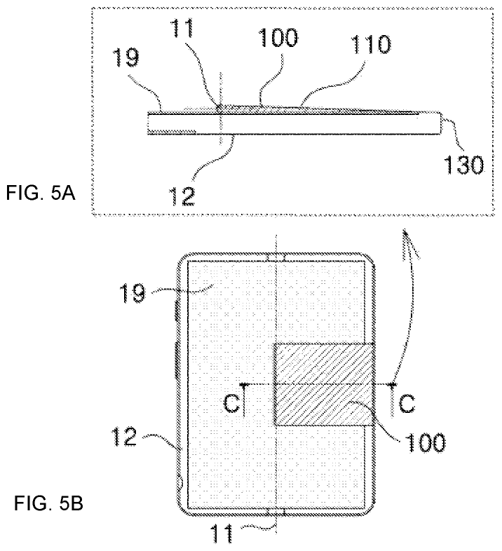

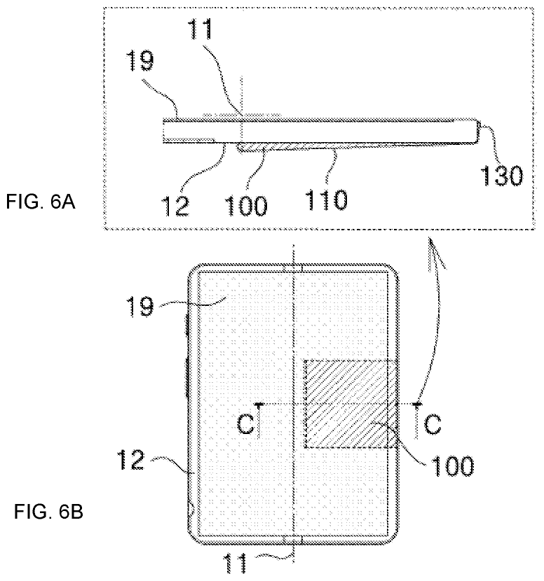

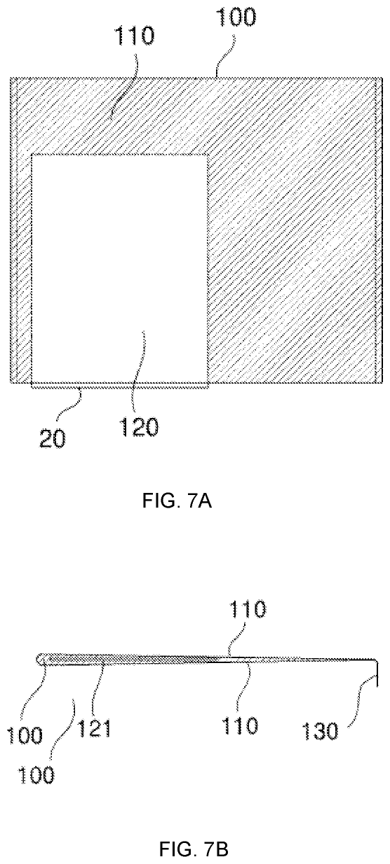

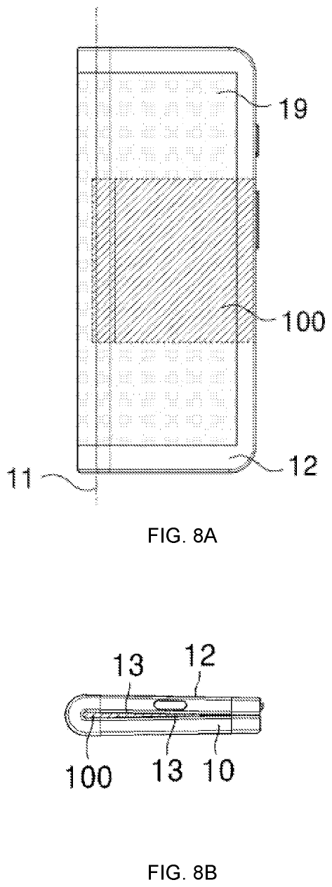

FIGS. 3A and 3B are front and plan views showing a folding space insert according to the present invention which is applied to an in-folding type image display device being in a folded state, FIGS. 4A and 4B are sectional views taken along the lines A-A and B-B of FIG. 3 A, FIGS. 5A and 5B are plan and sectional views showing the folding space insert applied to an in-folding type image display device being in an unfolded state and taken along the line C-C, FIGS. 6A and 6B are plan and sectional views showing a state where the folding space insert of FIGS. 5A and 5B moves and taken along the line C-C, FIGS. 7A and 7B are concept views showing a state where a credit card is accommodated into the folding space insert, and FIGS. 8A and 8B are concept views showing a folding space insert according to the present invention that is applied to an out-folding type image display device being in a folded state.

As shown in FIGS. 3A to 8B, a folding space insert 100 is applied to a given internal area of the folding space 14 as the empty space formed by means of the inner folding surfaces 13 and an inner circumferential surface of the fold axis 11 when the foldable image display device 10 is in a folded state and is selectively moved to the outsides of the inner folding surfaces 13 when the foldable image display device 10 is in an unfolded state in such a manner as to be located in the folding space 14 again if the foldable image display device 10 is changed to a folded state, wherein the folding space insert 100 is configured to allow one side to come into contact with any one side inner folding surface 13 forming the folding space 14 to support an external force applied thereagainst and to allow the other side to come into contact with the other side inner folding surface 13 to transfer the external force thereto, thereby supporting and dispersing the external force applied from the outer folding surfaces 12 and moving to the outer edges of the inner folding surfaces 13 when the foldable image display device 10 is unfolded.

The folding space insert 100 has insert contact surfaces 110 whose one side is flat to thus come into contact with the inner folding surfaces 13 or is changed to flat surfaces when contacted with the inner folding surfaces 13, so that the folding space insert 100 can come into close contact with the inner folding surfaces 13 forming the folding space 14.

As shown in FIGS. 4A and 4B, FIGS. 6A and 6B, and FIGS. 7A and 7B, the folding space insert 100 is connected to the foldable image display device 10 or a separate protection casing by means of an insert connection string or connection plate 130, and the free end portion of the folding space insert 100 connected to the foldable image display device 10 by means of the insert connection string or connection plate 130 is located in the given internal area of the folding space 14, so that when the foldable image display device 10 is in a folded state, it is hard to recognize the application of the folding space insert 100 and there is no danger that the folding space insert 100 may be lost.

For example, the folding space insert 100 as shown in FIG. 3A to 8B has the shape of a square, but it may have any one of decorations (heart, clover, cloud, animal, symbol, etc.), characters (person, national flag or logo, thing created, etc.), shapes (polygon, circle, oval, etc.), and a pierced shape (pierced at center or portion thereof).

Further, as shown in FIGS. 7A and 7B, the folding space insert 100 includes a credit card accommodation space portion 120 and a credit card entrance 121 formed on one portion thereof, and without any protection casing having a separate accommodation function, accordingly, the folding space insert 100 accommodates a credit card thereinto through the folding space 14.

As shown in FIG. 3A to 8B, the insert contact surfaces 110 as the flat surfaces of the folding space insert 100 have inclinations corresponding to the folding space 14.

The insert contact surfaces 110 coming into contact with the inner folding surfaces 13 are made of a fabric or material made of ultra fine fibers so that they clean fingerprints and materials after touches which may remain in the inner folding surfaces 13 forming the folding space 14.

Further, the folding space insert 100 has to support the external force applied to the folding space 14, and accordingly, it is made of a non-flexible material like metal, wood, and plastic or a limitedly bendable material like urethane.

As shown in FIGS. 8A and 8B, the folding space insert 100 is applicable even to the out-folding type image display device where the folding space 14 is formed, and in this case, the functions as suggested in FIG. 3A to 7B are applied to the folding space insert 100 in the same manner as each other. Accordingly, they will be not explained anymore.

Hereinafter, a member for the foldable image display device 10 where the folding space 14 is formed, which is separated from or combined with the folding space insert 100, will be explained.

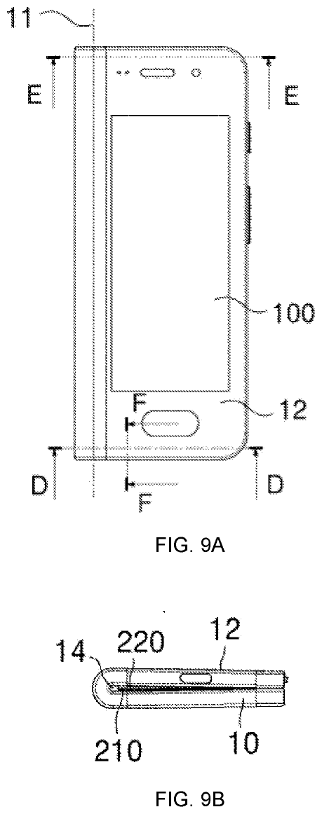

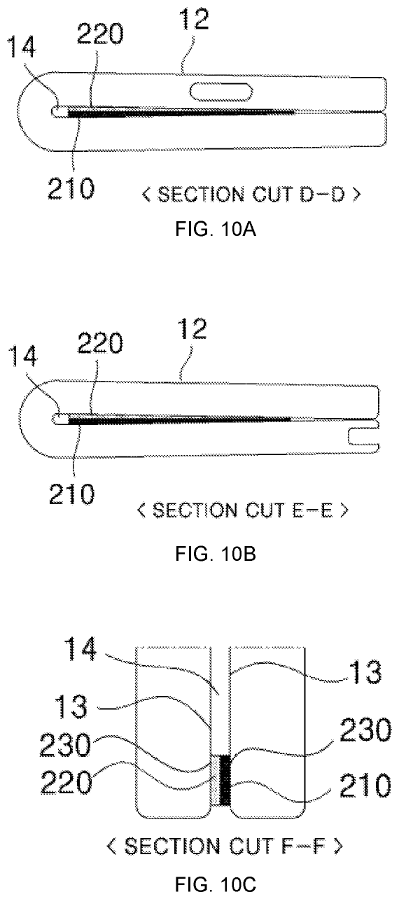

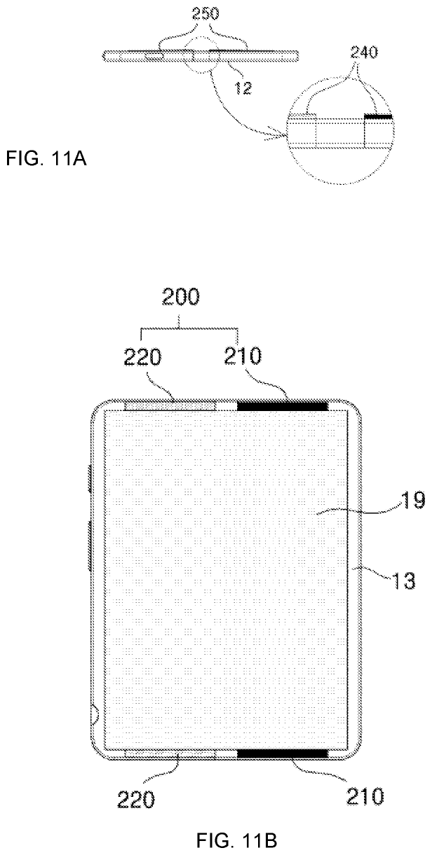

FIGS. 9A and 9B are front and plan views showing a folding space support according to the present invention which is applied to an in-folding type image display device being in a folded state, FIGS. 10A to 10C are sectional views taken along the lines D-D, E-E, and F-F of FIG. 9A, and FIGS. 11A and 11B are front and plan views showing the folding space support according to the present invention which is applied to the in-folding type image display device being in an unfolded state.

As shown in FIGS. 9A to 11B, one or more folding space supports 200 are located on areas on which the folding space insert 100 applied to the folding space 14 is not laid, on both side ends into which the folding space 14 is penetratingly open, and on an area on which a flexible display 19 is not located.

Unlike the folding space insert 100 selectively applied or movable to the outside of the given area, as shown in FIGS. 9A to 11B, the folding space supports 200 are fixed to the inner folding surfaces 13 of the foldable image display device 10.

As shown in FIGS. 9A to 11B, each folding space support 200 includes a first folding space support 210 whose one side surface is fixedly bonded to a given area of the inner folding surfaces 13 forming the folding space 14 and a second folding space support 220 whose one side surface is fixedly bonded to the inner folding surface 13 located on the opposite side to the side at which the first folding space support 210 is located around the fold axis 11 in such a manner as to supportingly come into contact with a protruding portion of the first folding space support 210 when the foldable image display device 10 is in a folded state and to be separated from the first folding space support 210 when the foldable image display device 10 is in an unfolded state.

The height of the folding space 14 is high, and in this case, if each folding space support 200 has a single shape, a protruding portion of the folding space support 200 is excessively exposed to the outside from the inner folding surfaces 13 unfolded to thus have a plane, thereby being caught in a user's hand.

So as to avoid such a problem, as shown in FIGS. 9A to 11B, each folding space support 200 has one pair of the first folding space support 210 and the second folding space support 210 separable from each other around the fold axis 11, so that the folding space support 200 is halved in the protruding height, thereby improving an outer appearance and lowering the possibility that it is caught by the user's hand during his or her touch.

Like this, the first folding space support 210 and the second folding space support 210 separable from each other into two parts include support fixing surfaces 230 bonded or fixed to the inner folding surfaces 13, support contact surfaces 240 formed by allowing the protruding surfaces on the opposite side to the support fixing surfaces 230 to come into contact with each other, and support slant surfaces 250 formed slantly along the edges of the support fixing surfaces 230 and the support contact surfaces 240.

As shown in FIGS. 9A to 10C, the folding space supports 200, which allow the support contact surfaces 240 of the first folding space supports 210 and the second folding space supports 220 located on both side ends of the fold axis 11 of the foldable image display device 10 to come into contact with each other when the foldable image display device 10 is folded, serve to close outer edges open penetratedly into the folding space 14, thereby preventing foreign matters from entering the folding space 14.

Further, the support contact surfaces 240 of the first folding space supports 210 and the second folding space supports 220 are kept in contact with each other when the foldable image display device 10 is folded, thereby supporting an external force applied to the folding space 14 and also dispersing the external force to edge portions of the foldable image display device 10, where stiffness is the highest.

If the height of the folding space 14 is relatively low, unlike the folding space 14 as shown in FIGS. 9A to 11B, each folding space support 200 is not divided into two parts, and each folding space support 200 having one shape is applied to any one side folding surface 13 around the fold axis 11.

If each single-shaped folding space support 200 is applied, while not being divided into two part, of course, any one of the first folding space support 210 and the second folding space support 220 as suggested in FIGS. 11A and 11B is not provided.

Further, each single-shaped folding space support 200 includes a support fixing surface 230 bonded or fixed to the inner folding surface 13, a support contact surface 240 adapted to allow the single-shaped folding space support 200 to supportingly come into contact with the other side inner folding surface 13, and a support slant surface 250 formed slantly along the edges of the support fixing surface 230 and the support contact surface 240. In this case, each single-shaped folding space support 200 is similar to each folding space support 200 having the first folding space support 210 and the second folding space support 220 as the two divided parts, and the protruding height of the single-shaped folding space support 200 is just different from that of the folding space support 200 divided into the two parts. Accordingly, an example where the single-shaped folding space support 200 is applied to the foldable image display device 10 will be not shown in the attached drawings.

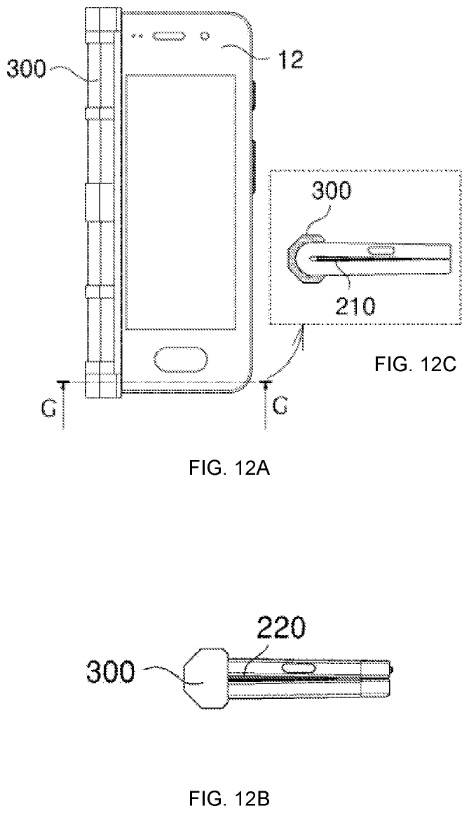

FIGS. 12A to 12C are front, plan, and sectional views showing an edge cover additionally provided to the folding space insert of FIGS. 8A and 8B.

As shown in FIGS. 12A to 12C, even if the folding space insert 100 and the folding space supports 200 are applied to the foldable image display device 10 where the folding space 14 is formed, the circumferential surface of the fold axis 11 is not protected sufficiently.

To solve such a problem, accordingly, an edge cover 300 is additionally provided for the foldable image display device 10.

So as to prevent the edge cover 300 separated from the fold axis 11 from being lost, an edge cover connection string (not shown) is provided in such a manner as to allow one side end to be connected to the folding space insert 100, the folding space supports 200, or a body of the foldable image display device 10.

The folding space supports 200 each having the first folding space supports 210 and the second folding space supports 220 as the two divided parts or each having one shape are separate accessories detachable from the foldable image display device 10, and of course, they can be provided integrally as a part of the foldable image display device. In this case, the foldable image display device 10 includes: a foldable body having the flexible display 19, the fold axis 11, the inner folding surfaces 13 located at the inner surfaces thereof when folded, the outer folding surfaces 12 located at the outer surfaces thereof when folded, and the folding space 14 as the empty space formed by the inner circumferential surface of the fold axis 11; and the single-shaped folding space supports 200 whose one side is bonded or fixed to the given area of the inner folding surfaces 13 forming the folding space 14 or the folding space supports 200 each having the first folding space support 210 and the second folding space support 220 as the two divided parts.

Each folding space support 200 having the first folding space support 210 and the second folding space support 220 as the two divided parts or each single-shaped folding space support 200 includes the support fixing surfaces 230 bonded or fixed to the inner folding surfaces 13, the support contact surfaces 240 formed by allowing the protruding surfaces of the first folding space supports 210 and the second folding space supports 220 on the opposite side to the support fixing surfaces 230 to come into contact with each other when the foldable image display device 10 is in a folded state or formed by allowing the single-shaped folding space supports 200 to come into contact with the other side inner folding surface 13, and the support slant surfaces 250 formed slantly along the edges of the support fixing surfaces 230 and the support contact surfaces 240 of the first folding space supports 210, the second folding space supports 220, and the single-shaped folding space supports 200.

When the foldable image display device 10 is in the folded state, the single-shaped folding space supports 200 or the first folding space supports 210 and the second folding space supports 220, which are kept in touch with each other, serve to close outer edges of the folding space 14.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A foldable image display device having a foldable body with a fold axis as folding reference when folded, inner folding surfaces located at the inner surfaces thereof when folded, and outer folding surfaces located at the outer surfaces thereof when folded and a flexible display applied to the inner folding surfaces, so that when folded, the foldable image display device has folding space as empty space formed by the inner folding surfaces and an inner circumferential surface of the fold axis, the foldable image display device comprising folding space supports located on the inner folding surfaces to prevent foreign matters from entering the folding space when folded,
wherein the folding space supports comprise:
a first folding space support; and
a second folding space support so that when the foldable image display device is unfolded, a protruding height of each folding space support is lowered, the first folding space support being applied to a given area of the inner folding surface forming the folding space and having a support slant surface slant from a portion protruding therefrom toward the outside of a screen display surface, and the second folding space support being applied to the opposite side inner folding surface to the side where the first folding space support is applied with respect to the fold axis, having a support slant surface slant from a portion protruding therefrom toward the outside of the screen display surface, and being located to face the first folding space support when the foldable image display device is in a folded state.

2. The foldable image display device according to claim 1, wherein support contact surfaces of the first folding space support and the second folding space support at least partially touch each other when the foldable image display device is in the folded state, so that the folding space supports occupy the outer edges open penetratedly into the folding space to prevent the foreign matters from entering the folding space.

3. The foldable image display device according to claim 1, wherein the first folding space support and the second folding space support become gradually reduced in heights protruding therefrom from the fold axis, and the protruding portions thereof being located on the outside of the screen display surface of the flexible display in such a manner as to have inverse V-shaped upward protruding slant states with respect to the fold axis.

4. A foldable image display device having a foldable body with a fold axis as folding reference when folded, inner folding surfaces located at the inside thereof when folded, and outer folding surfaces located at the outside thereof when folded and a flexible display applied to the inner folding surfaces, so that when folded, the foldable image display device has folding space as empty space formed by the inner folding surfaces and an inner circumferential surface of the fold axis, the foldable image display device comprising:
single-shaped folding space supports applied to the inner folding surfaces, without any division in protruding heights therefrom with respect to the fold axis, in such a manner as to close penetratedly open portions of the ends of the fold axis to thus prevent foreign matters from entering the folding space when folded,
wherein each folding space support is applied to any one side inner folding surface with respect to the fold axis and has a support slant surface slant from a portion protruding therefrom toward the edges of the folding space.
